(19) United States
(12) Patent Application Publication
(10) Pub. No.: US 2017/0333165 A1
(43) Pub. Date: Nov. 23, 2017

(54) System and Method for Making Dental/Medical Devices Using Patient Mouth as Articulator

(71) Applicant: Arnold I. Liebman, Brooklyn, NY (US)

(72) Inventor: Arnold I. Liebman, Brooklyn, NY (US)

(21) Appl. No.: 15/672,814

(22) Filed: Aug. 9, 2017

Related U.S. Application Data
(63) Continuation-in-part of application No. 14/615,974, filed on Feb. 6, 2015, now Pat. No. 9,744,009.
Application No. 14/615,974 is a continuation-in-part of application No. 13/905,642, filed on May 30, 2013, now Pat. No. 9,545,294.

(51) Int. Cl. A61C 13/00; A61C 11/08; A61C 13/097; A61C 9/00

(52) U.S. Cl. CPC A61C 13/0004; A61C 13/097; A61C 11/081; A61C 9/004

(57) ABSTRACT

Creating a replacement tooth or set of teeth by using the patient's mouth as an intra-oral articulator. Also, a medical appliance can be created by using the patient's mouth as an intra-oral articulator. A mechanism is fitted within the patient's mouth which can hold one or more replaceable teeth. The dentist adjusts the size, color, location and placement of the teeth within the patient's mouth until a best fit is achieved. Then, the device, with the artificial and temporary teeth secured thereto, is further processed into a final replacement tooth (teeth). Also, the present system can be used for any dental or medical appliance in or about the mouth, i.e., using the mouth of the patient as the intra-oral articulator will result in superior results.

### RELATED APPLICATIONS AND CLAIMS OF PRIORITY

This application is a continuation in part of an application and claims priority to U.S. application Ser. No. 14/615,974 filed Feb. 6, 2016, now U.S. Pat. No. ______, which was a continuation-in-part application and claims priority upon U.S. Pat. No. 9,545,294, issued Jan. 17, 2017, which was filed May 30, 2013, assigned Ser. No. 13/905,642, the specifications and teachings of both of which are expressly incorporated by reference.

### FIELD OF THE INVENTION

The present invention relates to a method and system for making new, replacement dental components, e.g., dentures, bridges, teeth, and other dental/medical appliances and devices for the mouth of a patient by using the patient's own, actual mouth as the site for adjusting, fitting and seeing the sample or representative components in place by themselves or with other components (natural teeth, for example) prior to the new components being finished into long term dental or medical grade components and materials. According to the present invention, the mouth of the patient is provided with a temporary or trial dental/medical piece-holding device or component which will hold and allow adjustment and/or replacement of temporary pieces or components, so-called trial, replacement teeth, the latter of which can be individually or collectively switched out, mixed and matched, in size, color, orientation, etc. within the mouth, while held by the holding device and then when the patient or dentist, technician or doctor is satisfied with the components and their shape and orientation, even color and size, as seen in the patient's actual mouth, the same can be held in relative place to one another, by locking them into or onto the holding device or component and then the holder and arranged components removed from the mouth as a unit. Suitable post fitting techniques, e.g., 3 D printing, CAD-CAM manufacture, dental labs, scanning and printing, etc. of a final denture set, medical appliance, or device/piece(s) for the mouth is thus created which will fit precisely, look appropriately, and easily fit back into the patient's mouth. In effect, the present invention contemplates the use of the patient's actual mouth as a substitute and more accurate mechanical articulation device, distinct from the prior art's use of a separate, outside the mouth, yet physical mechanical articulator. Using the technique of the present invention, the dentist, medical practitioner or other user can actual create a set of teeth, dentures, and/or other medical products, within the patient's mouth, using the patient's own mouth as the “testing ground” for the components and/or the device before the holder of the components is removed from the mouth and the holder and/or components sent downstream for further and final processing (scanning, molding, 3-D printing, etc.). This allows, in the case of dentures, the patient and the dentist to actually see the fit, size, shape, color and placement of the temporary tooth or set of teeth for a replacement tooth, a bridge, or even a complete set of dentures within the patient's actual mouth before the same are removed from the mouth (while keeping all in relative place) and then made into a long term replacement tooth, bridge, and/or a full set of dentures. The artificial and temporary (mix and match) teeth to be held to the device held in the mouth are held in place by a mechanical interaction between them and the mechanical component or mechanism within the patient's mouth, the “holder.” The sample teeth can be mixed and matched into the mouth of the patient, with the dentist adjusting orientation, placement, size, color, shape, etc. The replacement teeth are thus able to be first “mixed and matched” with other or real teeth-like components, all to be temporarily held in the patient's mouth, until the right look is achieved, while dental principles are maintained. Then, the holder, with the temporary teeth, are secured with respect to one another and to the holder, all removed from the mouth as a unit, and then further processed into final and long term teeth, bridges, medical appliances, and/or dentures.

The present invention can be used with other dental or medical devices and appliances as well as for other medical purposes all within the concept of the present invention which relates to using the patient's mouth along with some mechanical holding device which allows the practitioner to mix and match other teeth within the mouth. As the temporary components are held in place, the dentist and the patient can see what the result of the final processing will be. Thus, the present invention allows the user and the patient to determine the “best” configuration of the same for the patient, and, then, securing the same in relative place on the holder, held within the patient's mouth during fitting, the holder and artificial temporary teeth can be “locked down” for relative holding of the same in position, then the holding unit and teeth removed from the mouth and then directed downstream in the process for further processing into the final configuration of the dental device or other medical appliance.

Using the present invention provides a simple, quick, accurate means of testing, within the actual mouth of the patient, the prototype of the device/appliance. The holder and individually attachable tooth(teeth) can be used to fit the patient's mouth so that when the holder with selected final (but temporary) teeth is removed, the further processing will result in a set of durable replacement teeth, a bridge, a set of dentures. This is a result of use of the components which were first adjusted and modified in the patient's mouth, as held on the mechanical holding component within the patient's mouth.

A dentist can avoid the step(s)) of first creating a model of a patient's mouth and fitting one or more teeth therein on a mechanical articulator (external to the patient's mouth) if the dentist uses the present inventive concept and method of actually using the patient's own mouth as the articulator. This can be done by using some mechanical device placed into the patient's mouth which is capable of holding the individual teeth or set of teeth or other medical/dental appliance, so that the dentist or practitioner can see the relative fit and placement of the same actually within the patient's mouth and, then, when satisfied as to a “best fit” (within dental principles) the dentist can remove the mechanical device form the mouth with the temporary tooth, teeth, etc. and send the same onto the next step for further processing. There, by scanning, molding, 3 D printing, etc. a final tooth, set of teeth, bridge, and/or denture (or a medical appliance), can be made.

Primarily, the present invention can be used for forming replacements for one or more teeth for a patient, a bridge, a set of dentures, even a tooth or set of teeth intended to be implanted. The general concept is applicable to all devices for medical and dental purposes. The concept contemplates using a temporary holding device within the patient's actual mouth and using it as an intra-mouth articulation device. This enables the dentist to more easily, quickly, accurately and with superior end product, provide a set of artificial teeth and teeth structures. The invention is a system and method for use of the mouth and a holding device as an integrated dental system with temporary teeth capable of being placed on the holder, removed and replaced, all while mixing and matching the tooth, teeth, until the final desired look is achieved. The present concept is a method for forming dentures, partial dentures, implants, teeth and other medical appliances, while using the mouth as the testing ground, a dental articulator, all to aid in other dental/medical device creation procedures and products.

Specifically, the present invention discloses a new device and associated components for use within an individual's mouth to provide an intra-oral dental articulator for use in forming dental impressions, one or more teeth, implants, bridges, dentures, dental appliances, medical products for the mouth area, etc. and even for the creation of a set of partial or complete dentures preferably during a single patient visit.

### BACKGROUND OF THE INVENTION

As the present invention was initially created for use by a dentist in creating dentures, the present invention is described in that general area of use but it should be appreciated that the invention and concept is broader than that and extends to using a patient's mouth as a mechanical articulator for making dental/medical components and appliances. Yet, for ease of reading and understanding, the preferred embodiment is described in connection with dentures and creating them by use of a mechanical device which is a holder which is fit within the patient's mouth which then allows the patient's mouth to be a mechanical articulator, thus dispensing with the usual, prior art, physical and separate (external to the mouth) mechanical articulator. The present invention relates to the concept of using the patient's mouth as the intra-oral articulator. This is accomplished by supplying into the patient's mouth a holding device which is capable of accepting and holding one or more teeth in relative position. Then, when the full set of teeth to be created for permanent wear are “designed” by the dentist, the holding device with the set of teeth are held in relative place and the holder, with teeth, then removed. The holder and teeth are then molded, 3D printed, CAD-CAM printed, scanned, etc. and made into the final teeth, bridge, set of dentures for the patient.

As many individuals age they can become partially or completely edentulous i.e., they lose one or more teeth and, yet, gum tissue remains. This can be caused by a wide array of issues, including periodontal disease, tooth decay, improper nutrition, simple decay, developmental defects, genetic defects, and/or or trauma or other factors, presenting alone or in combination. When this occurs, individuals lose some or all of their teeth and should be fitted with one or more replacement teeth or a complete set of false teeth or bridges, implants, partial or full dentures, etc. (hereinafter often collectively referred to as “dentures” but it should be understood that the term is meant to be inclusive of everything and anything which a dentist or medical practitioner or related technician may need or select to remediate, diagnose or treat anything relating to a patient's mouth, yet, in the preferred embodiment, a patient's missing tooth or teeth, i.e., within the normal range of dentistry) to replace those having been decayed or lost or intentionally pulled for one reason or another. To remediate and solve this issue, edentulous patients or individuals in need often get dentures, which are prosthetic, false (often acrylic or porcelain) teeth constructed to replace missing teeth. Removable, partial dentures are used when an individual has lost only some teeth, and a complete set of dentures, or dental implants, can be used when an individual is substantially or fully edentulous. The process, in the past, is done by a qualified and licensed dental practitioner and often requires more than a single dental appointment for first taking appropriate molds, sending the same to a lab, and then fitting the results of the lab work into the patient's mouth. This is time consuming, expensive, possibly embarrassing to the patient until the dentures are provided, inconvenient to the patient, and often results in compromise in quality of end product. It often involves the use of a separate, outside the mouth, mechanical articulator to simulate the patient's mouth. The present invention, on the other hand, actually seeks to use the patient's own mouth as an articulator for creation of these dentures. This will result in superior results and allows the dentist and patient to “see” the temporary teeth in place in the mouth before final processing.

It is believed that a one-time, possibly single visit to the dentist's office, which will allow a fully or partially edentulous patient to go from a state of edentulousness to beautiful smile, with a partial or complete set of dentures would be a boon to the patient, to the dentist, and to the dental manufacturer supplying the various components.

The present invention discloses the individual components, an integrated system, and a comprehensive method for using the patient's mouth as an intra-oral articulator, i.e., the mouth is the testing site for a set of preliminary or temporary teeth. There, the samples of the teeth in size, shape, color and placement relative to one another can be “tried” on, and then preparing a set of dentures—partial or full—possibly in a single visit is achievable. By using the patient's own mouth as the holding chamber or cavity for the teeth to be used in the formation of dentures, a superior product is believed obtained. In effect, the present invention provides a mechanical device for allowing the patient's own oral cavity to serve as the articulator for preparation of the dentures or other medical/dental devices and appliances. Stated differently, by providing a new device, a “main frame” or articulator, i.e., a holding device for sample artificial teeth, preferably in the form of a disposable set of new dental trays for making impressions of the gums, a holding device for the teeth is provided. This set of trays is inserted into the patient's mouth and sample teeth can be preliminarily fitted to the device, removed and replaced by other sample teeth (changing in size, color, placement, etc.) by the dentist within the mouth, until the shape, color, size, spacing, location, dental “fit” is achieved according to dental principles. The temporary teeth are removably held to the device which is held within the patient's mouth, until the dentist and patient are satisfied, and then the holding device and the teeth are secured in place with respect to one another. The holder, with the teeth is then removed and further and final processing is done to form final and long term dentures. The dentures can thus be made to fit in a single visit to the dentist. The cost savings, time savings, comfort to the patient, the dentist's profitability, etc. are all maximized.

So, in effect, the present invention relates to use of the patient's mouth as an articulator or testing ground for manipulation and creating the visual look and fit of the teeth, which are held to a device within the actual mouth, then secured with respect to one another, then all removed and processed into the final end product, in the preferred embodiment, a set of dentures.

Finished dentures are preferably composite or acrylic-molded teeth which are integrated into an acrylic set of gums which, as a unit, uppers and lowers, are then adhered or form fit into the mouth of a patient, fitting on the gums of the patient. These replacement teeth are most desirably located where the patient's original tooth or teeth have been lost, removed or destroyed. But, of course, some use of dentures can be made to make a whiter set of teeth and/or a smile formed of a set of teeth which is superior to the original set of the patient. Of course, the new tooth or teeth are meant to conform to and “match” the patient's original mouth and teeth but they can either replace lost teeth or may provide an enhanced set of teeth, all to provide a suitable smile with suitably shaped and colored new teeth for the patient's mouth, complexion, smile lines, etc. For purposes of this disclosure, all types of dental or medical procedures made possible by the present invention, namely full dentures, partial dentures, implant retention, bridges, and other medical and/or dental appliances, will often be hereinafter referred to collectively as “dentures.” But, it must be appreciated that the present invention is intended to cover all dental and medical new products formed by use of the mouth of the patient as the articulator for the end product or device which is being made for the patient's mouth. That is the thrust of the present invention.

### DESCRIPTION OF PRIOR ART

Currently, to create and make a set of dentures, conventional mechanical and physically separate articulators outside of the mouth are used. This can create errors in the measurement, angulation, occlusion, and placement of dentures if they do not precisely match the shape of the mouth once placed therein. One or more fittings may be required and/or the dentist may need to adjust or file/shave the provided dentures received from the lab. The present invention aims to overcome this issue by presenting new components and a new system and method for creating a set of dentures using the patient's own mouth as the mechanical articulator or trial site, rather than reliance upon an external articulator device. There is also a need for a set of dentures to be created for a patient in a quick, relatively inexpensive, and easy fashion, as opposed to a process which requires multiple dental office visits to complete. The present invention provides an accurate and quick system and method for making dentures in a single visit. To the inventor's knowledge, no other person or entity has considered using the patient's mouth as the site for a mechanical device to be placed therein such that teeth can be temporarily placed thereon so as to “build” a set of dentures or teeth in size, shape, location, color, fit, etc. in the mouth and then, to hold the teeth in relative placement so as to remove the holder and temporary teeth together, to be then further processed (3D printing, scanning, molding, traditional dental lab work, CAD-CAM, etc.) into a s final set of dentures. The present invention uses the patient's own mouth as the articulator so that the new teeth can be actually seen in the patient's mouth, with other teeth, along with the patient's entire face, smile muscles, ears, etc. This concept of using the patient's mouth as the intra-oral articulator is novel and results in superior aesthetics. The mouth is first provided with a simple holding device which will hold the “mix and matched” temporary teeth. Then, when the required temporary teeth are provided, in size, shape, color, placement, etc. all as determined according to standard dental principles, the holding device and the temporary teeth are secured in place. The holder with the teeth then removed from the mouth. The dentist can then process the same into a final set of dentures, or a tooth, a dental and/or medical appliance.

### SUMMARY OF THE INVENTION

A system and method for creating a set of dentures is revealed for a patient by using the patient's mouth as the articulator. Preferably comprising a customized lower dental tray for creating an impression of the patient's lower ridge of the mouth, a customized upper total or partial (herein the latter is often referred to as the palatal) dental tray for creating an impression of the patient's upper mouth portion including the palatal arch, and a mechanism for holding in place in the mouth, connected to the trays, is a mechanism for holding one or more teeth on a temporary basis. The teeth can be interchanged for other teeth of different shape, size, color, orientation according to traditional dental principles. Ultimately, the dentist creates a set of temporary teeth in the mouth of the patient that suit the patient, the dentist and dental standards. The held in the mouth temporary teeth will be viewable along with the patient's other teeth, if any, but along with the lips, smile muscles, orientation of all vis a vis the patient's face and mouth. When acceptable, the teeth, on the holding and support device are removed and the temporary teeth, color, shape, size, fit, orientation, etc. are processed from that holder and those temporary teeth to a final set of dentures. The use of the mouth as the articulator or testing area for the temporary teeth, to then be made into final replacement teeth, is the thrust of the present invention.

One form of the device, is seen in U.S. Pat. No. 9,545,294, issued Jan. 17, 2017. That shows a main frame device for insertion in the mouth and thus using the mouth as an intraoral articulator. A set of impression like trays is provided, for the lower gums and for the palatal arch. A mechanism is provided for adjustably vertically spacing them apart and then locking in the separation and spacing. The main frame disclosed therein is magnetically held between the inventive impression trays and allows for vertical adjustment of the spacing between the trays. The main frame serves as a first embodiment of a temporary tooth holding device. The temporary teeth are selectively provided to the main frame and held therein by the mechanical inter-engagement of the rear of the teeth and a slot in the main frame. Bottom Line: the patient's mouth is the articulator for creating a set of temporary teeth for ultimately creating a set of permanent dentures. In a different embodiment of a holding device for use in the patient's mouth and to enable the mouth to be an intra-oral articulator, one is directed to the US Patent which issued from U.S. patent application Ser. No. 14/615,974 filed Feb. 6, 2016. There a set of impression like trays are provided and described. The lower tray is separated from the palatal arch by a simple threaded vertical screw. It is locked in place. The lower tray is provided with an arch shaped (matching the curvature of the mouth from side to side) vertically extending set of ribs. Temporary teeth, provided with wax on their backs, can be secured to the ribs. Mixing and matching teeth can be done by the dentist until the right “look” is achieved. Then, the lower tray, with the ribs supporting the location, size, spacing, shape, color, etc. of the temporary teeth, is removed. Here, too, the patient's mouth is used as the actual articulator and the dentist adjusts the teeth to the vertical ribbing according to dental principles. The use of a tooth holding support for the temporary teeth within the patient's actual mouth (in the case of dentures being the end product) is the inventiveness of the present invention, i.e., using the patient's own mouth as an articulator and thereby avoiding the use of a separate mechanical articulator, outside of the patient's mouth. Clearly, having the patient's actual face, muscles, and mouth involved in the process of creating new dentures is far superior for the desired end result, a natural, fitting, lovely smile that suits the face but particularly the mouth of the patient.

This temporary tooth, teeth or component-holding main frame or set of ribs secured to an impression tray are just two examples of the concept disclosed herein. The importance of using the mouth as an intraoral articulator is the “key” to the present invention. Whether the main frame of the Patent first issued or the impression trays and vertical ribs of the second patented system are used, the invention and general concept is the use of the patient's own mouth as the articulator. After the temporary teeth are adjusted and finalized by the dentist, the main frame is “locked down” or the teeth to the ribs are secured (possibly by curing) and the main frame or impression trays then removed. Then, the final dentures are created by dental labs, by 3D printing of dentures, by molding, CAD-CAM, scanning, whatever suitable molding and dental processing is then available.

As a component of the present invention in connection with the creation of replacement teeth or a set of dentures, one or more sets of individual or groups of teeth or units of dentures need be available. This allows the dentist to select from the sets, by size, shape, color, etc. the tooth to be held by the holding mechanism within the mouth. The teeth can be swapped out until the teeth are correct, in terms of color, size, placement, etc. The position of the units of temporary teeth are preferably adjusted in the mouth with relation to one another and then they locked in place. The trays and/or in the version of the invention using the main frame and now having the temporary teeth secured thereto, are then removed from the patient's mouth, and then used to create the desired end product, a set of dentures. These can be made by use of 3D printing, CAD-CAM, scanning, molding, and other dental lab processing steps, etc. But since the relative orientation of the holding ribs and the teeth (or the slot and the forks of the temporary teeth shown in the first issued US patent) with respect to one another are all fixed, all with respect to one another and as placed and seen in the patient's own mouth, a superior result is obtained. Seeing the teeth within the patient's actual mouth before the dentures are processed in final form is important to providing a superior product. The present invention provides that.

The present invention allows for creation of an accurate set of dentures, using the patient's mouth as the articulator, and providing a system and method to do so in a single visit, thereby minimizing the time required for this process.

### DETAILED DESCRIPTION OF THE PREFERRED EMBODIMENT

Description will now be given of the invention with reference to the preferred use of the same in connection with creation of dentures. The devices shown and described in the first US Patent identified above and then the disposable set of impression trays shown and described in the second issued US Patent to the same inventor are merely the currently considered best mode for accomplishing the desired end goal—a set of dentures for a patient, using the patients' own mouth as an actual articulator.

The present invention was taught and described in both of the issued and above referred to US Patents of the same inventor. It should be understood that these figures are exemplary in nature and in no way serve to limit the scope of the invention as the invention will be defined by the claims herein, as interpreted by the Courts in an issued US Patent.

The present invention concerns the concept or method for preparing a set of devices, whether dentures, teeth, implants, bridges, or other medical appliances, by using the patient's own mouth as the articulator.

The system and method contemplates placement of a device in the patient's mouth which will hold in relative place one or more teeth (or another article). When the teeth or other article is located in position, in terms of its size, placement, color, shape, with respect to the other teeth and the patient's mouth, the same is secured in place. Then, the holder and the teeth (or mouth appliance) is removed. Then, further processing by 3D printing, scanning, manufacturing, molding, CAD-CAM, dental lab processing is done to form the final version of the product. In some situations, the temporary mixed and matched components, held to the device in the mouth, can secure the components together so that no further final processing is required. But, again, the invention contemplates the use of the patient's own mouth as the “testing ground” or in the case of dentures, an intraoral articulator, for a better fit and to produce a superior end product.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed:

1. A set of dental devices for use in creating a dental appliance for the mouth of a patient comprising a palatal member shaped to the general shape of the palatal arch of a patient, a lower tray shaped to the general shape of the lower gums of the patient and further comprising a temporary tooth-holding mechanism for temporarily holding one or more artificial teeth to one or more of the palatal member and the lower tray, to achieve a best fit of temporary teeth according to dental principles, thus using the patient's own mouth as a mechanical articulator prior to finalization of the dental appliance.

2. A set of dental devices as claimed in claim 1 wherein said system is further comprised of a set of temporary teeth of any one or more differing colors, shapes, or sizes.

3. A set of dental devices as claimed in claim 1 wherein either or both of said palatal member or said lower tray are intended for one time use.

4. A set of dental devices as claimed in claim 2 wherein said temporary teeth are intended for one time use.

5. A system for creating artificial teeth for a patient using the patient's mouth as an intra-oral articulator comprising:
a lower dental tray for creating an impression of the patient's lower gum ridge of the patient's mouth;
an upper dental tray for creating an impression of at least a portion of the patient's upper mouth portion including the palatal arch; and
a tooth-holding mechanism for temporary and replaceable, secured holding of one or more artificial teeth thereon.

6. A system for creating artificial teeth for a patient as claimed in claim 5 further comprising:
a set of one or more artificial teeth comprised of one or more differing color, shape, and/or size each having a mechanical securement device for temporarily and replaceable securing said artificial teeth onto said tooth-holding mechanism.

7. A system as claimed in claim 5 further comprising a thin-profile, arc-shaped, occlusal plane capable of being held outside the patient's mouth for selectively securement to and removal from said tooth-holding mechanism.

8. A method of creating at least one final dental replacement tooth for the upper and/or lower mouth of a patient, while using the patient's mouth as an intra-oral articulator for placement of said tooth (teeth) thereon prior to forming said artificial tooth (teeth) into a final dental replacement tooth comprising:
a) providing a device within the patient's mouth with an artificial tooth-holding mechanism;
b) replaceably providing one or more artificial teeth with a holding means for temporary and then locked securement to said tooth-holding mechanism;
c) placing one or more of said artificial teeth onto said tooth-holding mechanism and adjusting the same according to dental principles; and then;
d) locking said artificial teeth in position on said tooth-holding mechanism and removing from the patient's mouth said device and said artificial tooth (teeth) for further processing into finished a final dental replacement tooth (teeth).

9. A method as claimed in claim 8 wherein said further processing includes the step of 3 D printing.

10. A method of making a dental/medical appliance for the mouth of a patient comprising the steps:
a) providing a mechanical device sized for placement in the mouth of the patient;
b) providing a mechanism for holding one or more temporary and replaceable components to said mechanical device within the patient's mouth;
d) using the patient's mouth as an intra-oral articulator for determining a best fit of the temporary and replaceable components;
e) removing the mechanical device from the patient's mouth; and
f) further processing to form a final version of the dental/medical appliance.

11. A method as claimed in claim 10 wherein said further processing comprises the use of 3 D printing.

12. A method as claimed in claim 10 wherein said mechanical device is intended for one time use.

13. A method as claimed in claim 10 wherein said dental/medical appliance is selected from the group consisting of a tooth, a bridge, an implantable tooth, a set of teeth, a set of dentures.

14. A method as claimed in claim 10 wherein said temporary and replaceable components comprise a set of teeth with differing sizes, shapes, and/or colors.

15. A method as claimed in claim 10 wherein said mechanism for holding comprises the mechanical cooperation of a vertical set of ribs on said mechanism for holding and wax on the rear of said temporary and replaceable components.
